(19) United States
(12) Patent Application Publication
(10) Pub. No.: US 2020/0341273 A1
(43) Pub. Date: Oct. 29, 2020

(54) Method, System and Apparatus for Augmented Reality

(71) Applicant: Tecgyver Innovations Oy, Tampere (FI)

(72) Inventor: Kimmo Jokinen, Tampere (FI)

(73) Assignee: Tecgyver Innovations Oy, Tampere (FI)

(21) Appl. No.: 16/396,805

(22) Filed: Apr. 29, 2019

(51) Int. Cl. G02B 27/01; G06F 3/01; G06T 7/20

(52) U.S. Cl. CPC G02B 27/017; G06F 3/013; G02B 2027/0138; G02B 2027/0187; G02B 2027/014; G06T 7/20

(57) ABSTRACT

There is disclosed a method for controlling power consumption of a wearable device, wherein the method comprises obtaining information from one or more sensors of the wearable device; using the obtained sensor information to form a sensed context profile; comparing the sensed context profile with a set of predetermined context profiles to determine a context of the wearable device; and using the determined context to adjust at least one operation of the wearable device related to augmented reality. There is also disclosed a wearable device and computer program product.

### TECHNICAL FIELD

The present invention relates to a method for producing and processing augmented reality information on a display of a device. The invention also relates to a system for producing and processing augmented reality information to be displayed by a display of a device.

### BACKGROUND

Augmented reality (AR) is a technique where some real information is mixed with simulated visual objects, for example. A user may wear an AR display which displays visual information of the environment where the user is located and the viewport of the visual information corresponds with the pose of the user's gaze, added with some simulated (e.g. visual information rendered by a computer) information. In other words, the user would see similar content without using the AR display than the visual information of the real environment except the simulated information. This kind of technique may also be called as a mixed reality (MR) indicating that the visual information comprises visual information of both the real environment and simulate information. The display the user is wearing for watching augmented reality may also be called as a head mounted display (HMD), because the best immersion can be produced when the display is near user's eyes and blocks direct view to the environment. The term AR glasses may also be used for the AR display in this specification.

One aim of the AR technique is to display the augmented reality objects as three-dimensional (3D) objects wherein when the user moves in the environment the object may be seen from different viewpoints accordingly. This kind of hologram tracking may improve the realistic feeling of the augmented reality.

The concept of virtual reality (VR) is quite similar to augmented reality but it usually is totally virtual, wherein the user may see visual information which may not be related to the actual environment the user is located. For example, many computer games where the user is using head mounted displays generate virtual reality environments and objects.

The concept of augmented reality also includes localization and environment sensing to improve the immersive effect. The system utilizing augmented reality scans the environment the user is located to detect objects, obstacles etc. in the environment. For example, the system may try to detect floor and walls of a room in order to set limits for movements and to place virtual objects to the scene at correct locations. A technique for that is called as a simultaneous localization and mapping (SLAM). However, such technique is not very comprehensive at this point and may fail if the user is outdoors.

Another disadvantage of such augmented reality systems is that the AR display is tethered to a separate processing unit and battery pack. The processing is hence performed by the processing unit and the AR display mainly renders the visual information for the user. The connecting cable between the AR display and the processing unit/battery pack may make the use uncomfortable and may disturb the immersive effect of the augmented reality application.

Some AR glasses have wireless connection with the processing unit, but they lack the localization capability and hologram tracking features.

### SUMMARY

There are provided new methods, systems, apparatuses and computer program products for augmented reality implementations. One aim of the present invention is to achieve a lightweight wearable device for producing augmented reality effects for the user. The device is battery operated and wirelessly tethered either to a mobile communication device or to an edge cloud of a wireless communication network. One aspect to take into consideration when designing such a device is the power consumption which should be minimized so that the device could operate several hours or a whole working day without re-charging during the day.

According to some embodiments the wearable device tries to determine the context regarding the use of the wearable device and on the basis of the determined context adjust the operation of the wearable device accordingly. For example, if the determined context reveals that the user of the wearable device is performing tasks which require much concentration so that too much additional stimuli would not make good for the user's actions, the wearable device might reduce operations related to augmented reality or even shut down augmented reality related elements to reduce the power consumption. According to another example, if the determined context is driving a vehicle, the wearable device might only produce augmented reality information which might reduce burden of the user, for example enhancing traffic signs which need to be noticed such as a speed limit.

According to a first aspect there is provided a method for controlling power consumption of a wearable device, wherein the method comprises:
obtaining information from one or more sensors of the wearable device;
using the obtained sensor information to form a sensed context profile;
comparing the sensed context profile with a set of predetermined context profiles to determine a context of the wearable device; and

using the determined context to adjust at least one operation of the wearable device related to augmented reality.

According to a second aspect there is provided a wearable device comprising:
a first circuitry configured to obtain information from one or more sensors of the wearable device;
a first circuitry configured to use the obtained sensor information to form a sensed context profile;
a first circuitry configured to compare the sensed context profile with a set of predetermined context profiles to determine a context of the wearable device; and
a first circuitry configured to use the determined context to adjust at least one operation of the wearable device related to augmented reality.

According to a third aspect there is provided a head mounted display comprising:
a first circuitry configured to obtain information from one or more sensors of the wearable device;
a first circuitry configured to use the obtained sensor information to form a sensed context profile;
a first circuitry configured to compare the sensed context profile with a set of predetermined context profiles to determine a context of the wearable device; and
a first circuitry configured to use the determined context to adjust at least one operation of the wearable device related to augmented reality.

According to a fourth aspect there is provided a method for producing and processing augmented reality information on a display of a device, wherein the method comprises:
obtaining information related to a location and pose of the device by using one or more sensors;
sending the location related information to a host device to retrieve environment data on the basis of the location related information;
receiving the environment data and data of at least one object from the host device;
producing an image of the object on the display at a location determined from the environment data and the information of the pose of the device.

According to a fifth aspect there is provided a method for retrieving environment data by a host device, wherein the method comprises:
receiving from a device information related to a location of the device;
retrieving from an environment database digital data related to the location;
determining a context of the device on the basis of the digital data and the location of the device;
obtaining data of at least one object related to the location;
sending the environment data, context data and data of the at least one object to the device.

According to a sixth aspect there is provided a method for optimizing power consumption of a device, wherein the method comprises:
obtaining information of a gaze point of a user on a display of the device;
using the gaze point to determine which area of the display belongs to a first part and which area belongs to a second part;
rendering visual data in the first part more frequently and with higher resolution than visual data in the second part.

In accordance with an embodiment, the method comprises producing and processing augmented reality information on a display of a device.

### BRIEF DESCRIPTION OF THE DRAWINGS

In the following, the invention will be described in more detail with reference to the appended drawings, in which

FIG. 1 shows an example of a system for augmented reality, in accordance with an embodiment;

FIG. 2 shows a block diagram of some operational elements of a wearable device, in accordance with an embodiment;

FIG. 3 shows a block diagram of some operational elements of a host device, in accordance with an embodiment;

FIG. 4 shows a block diagram of some operational elements of an access point of a wireless communication network, in accordance with an embodiment;

FIG. 5 shows an example of a view displayed by the wearable device, in accordance with an embodiment;

FIG. 6 shows an example of a view added with augmented reality objects and shown by the wearable device, in accordance with an embodiment;

FIG. 7 shows an example of a view displayed by the wearable device when navigating to a target, in accordance with an embodiment; and

FIG. 8 shows a principle of communication between entities of the system, in accordance with an embodiment.

### DETAILED DESCRIPTION

Information related to a real world can be obtained by some kinds of systems which gather e.g. locations of objects, geographical data, etc. and convert the obtained data to digital information, wherein the digital information forms a kind of digital image of the real environment. That data may be caller as digital twin data (a so-called “digital twin” data, DT data). Digital twin data relates to a digital replica of e.g. physical assets, processes, people, places, systems and/or devices at different geographical locations. The digital twin database 7 may be located in a so-called augmented reality cloud (AR Cloud). Digital twin data is not only visual, but also audible (and in the future it may be smelled as well). Digital twin data can contain the physical world features reconstructed to smallest detail level. Digital twin data can also be a parallel dimension, which does not exist as a physical reality. The augmented reality cloud comprises, in addition to the digital twin data, some metadata, augmented reality data etc. Contents of the AR cloud may be constantly updated when devices carried by people may collect data about their surroundings and deliver that data together with location data to the system where the AR cloud is running. It should also be noted that data of the AR cloud may be accessible by any device which is capable to process such data, unless the requested data is encrypted or the access of the data is otherwise limited to certain users/devices.

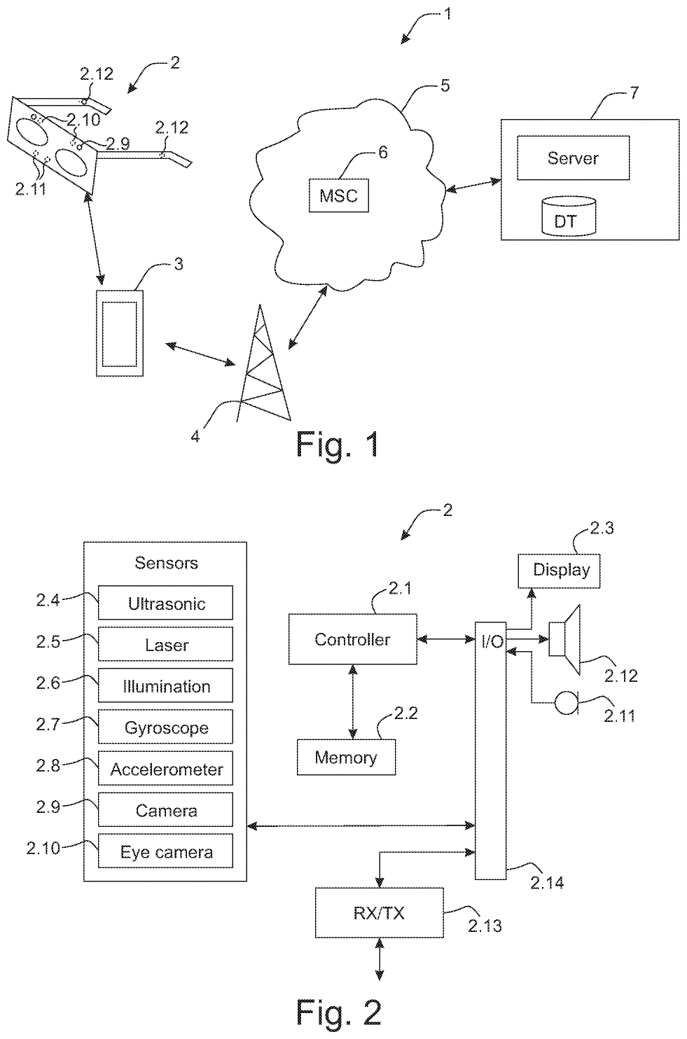

In the following, an example of a system 1 will be described in more detail with reference to FIG. 1. The system comprises a wearable device 2, such as a head mounted display. The wearable device 2 may communicate with a host device 3 utilizing some wireless communication technology. The wearable device 2 may also communicate with an access point 4 of a wireless communication network 5, such as a base station of a mobile communication network 5. In some embodiments, the access point 4 may implement a so-called mobile edge approach in which some computational tasks are performed by the access point 4 or some other computational element of the wireless communication network 5.

FIG. 2 shows a block diagram of some of the operational elements of the wearable device 2, in accordance with an embodiment. The wearable device 2 comprises a processing unit 2.1, such as a microprocessor. The wearable device 2 also comprises memory 2.2 for storing program code and data. The wearable device 2 further comprises one or more display units 2.3 for displaying visual information to a user of the wearable device 2. The wearable device 2 is also equipped with some sensors for detecting the environment of the wearable device 2. Different wearable devices 2 may have different sets of sensors, but some examples are provided here. There may be a short range radar 2.4 or a laser sensor 2.5 for detecting nearby objects and possibly measuring a distance from the wearable device 2 to the detected object. Another sensor may be an illumination sensor 2.6 for measuring the amount of illumination of the environment of the wearable device 2. Yet another sensor to be mentioned is a gyroscope 2.7, which can detect orientation and angular movements of the wearable device 2. Also an accelerometer 2.8 may be provided to detect linear movements of the wearable device 2. The wearable device 2 may still have one or more cameras 2.9, which capture visual information from the environment, and one or more microphones 2.11 for capturing audio information from the surroundings of the wearable device 2. Operation of some of the sensors will be described later in this specification. The wearable device 2 can also have one or more eye cameras 2.10 for obtaining information about user's eyes, such as a point of gaze of the user and/or a center of eye's retina and/or the size of a pupil, Hence, the wearable device 2 can utilize the information from the eye camera(s) 2.10 to perform eye tracking operations to find out, for example, where the user is looking at. Furthermore, the wearable device 2 may have one or more loudspeakers 2.12 to produce audible signals to the ears of the user.

The gyroscope 2.7 and the accelerometer 2.8 may form an inertial measurement unit (IMU for short), which tracks movements of the wearable device 2 preferably in a six-degrees-of-freedom (6DOF) manner. In some embodiments less than six degrees may be sufficient, such as three-degrees-of-freedom (3DOF).

Information provided by the inertial measurement unit can also be used for motion prediction and content asymmetric re-projection so that the system may predict how and to which direction the user is moving. Hence, this information can be used to predict, which data part is needed at each time point.

In other words, the motion prediction data is promptly returned to the host device 3 for cropping the essential data from the digital twin layer(s).

In accordance with an embodiment, when the wearable device 2 notices that the user is turning his/her head rather rapidly, e.g. rotating from left to right or vice versa, the display or a part of the display is “freezed” i.e. the display is not refreshed until at the end of the turning of the head. This is due to the fact that the user would not pay any attention to the information visible on the display during the turning of the head.

In some embodiments the amount of illumination may be obtained on the basis of information of one or more cameras 2.9, wherein a separate illumination sensor 2.6 may not be needed.

The wearable device 2 further comprises a first communication circuitry 2.13 for communicating with the host device 3 and/or a second communication circuitry 2.11 for communicating with the access point 4.

The above mentioned operational elements may be coupled via an interface circuitry 2.14 (I/O, Input/Output) to the controller 2.1 or the coupling between the elements and the controller may be realized in another appropriate way.

In FIG. 1 some of the sensors and their possible locations in the context of the wearable device 2 are illustrated but it should be noted that there are also other options for the location of the sensors.

In accordance with an embodiment sensor data i.e. information produced by one or more of the sensors may be converted to one or more sensed context profiles. The wearable device 2 may have access, e.g. from the memory of the wearable device 2, to a set of predetermined context profiles. Then, the wearable device 2 may compare the context profile(s) with the predetermined context profiles and that predetermined context profile which has the closest match with the sensed context profile may be selected as the current context of the wearable device 2. However, there may be more than two context which may be applicable to certain situations wherein it may be possible to obtain a match with more than one predetermined context profile. As an example, the user of the wearable device 2 may be walking indoors, wherein two contexts, indoors and walking, may result from the context determination procedure.

In accordance with an embodiment, a threshold may be used in the determination whether a predetermined context profile has a match with the sensed context profile.

In accordance with an embodiment, similarities between the sensed context profile and the predetermined context profiles are compared to obtain a confident measure for the predetermined context profiles. The confident measures are compared with a threshold to find out which predetermined context(s) provide context determination, which is enough confident; and those contexts indicated by those predetermined context profiles which were found out enough confident may then be selected to represent the current context of the wearable device 2.

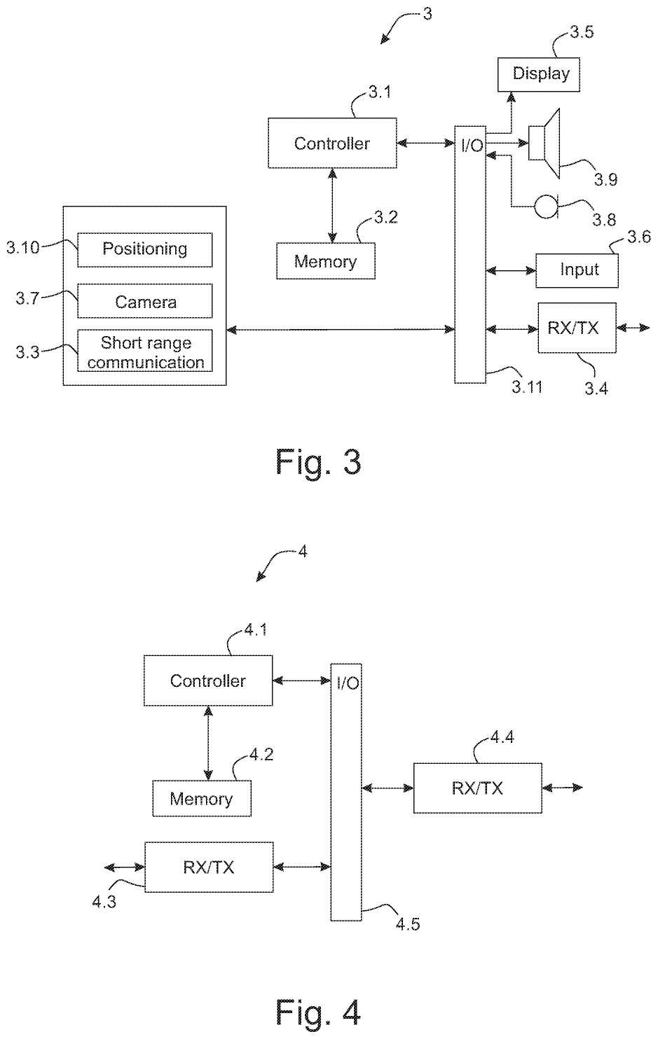

Next, some details of the host device 3 according to an embodiment will be described with reference to FIG. 3. The host device 3 is, for example, a wireless communication device such as a mobile phone, a smart phone etc. The host device 3 comprises a processing unit 3.1, such as a microprocessor. The host device 3 also comprises memory 3.2 for storing program code and data. The host device 3 further comprises a local communication circuitry 3.3 for communicating with the wearable device 2 and a distant communication circuitry 3.4 for communicating with the access point 4 of the wireless communication network 5. The host device 3 has a display 3.5 for displaying visual information to a user of the host device 3, and input means 3.6 such as a keypad and/or a touch sensor for receiving information, commands etc. entered by the user. The host device 3 may have one or more cameras 3.7, which capture visual information from the environment, one or more microphones 3.8 for capturing audio information from the surroundings of the host device 3 and one or more loudspeakers/earpieces 3.9 for producing audible information to the user. The combination of the display 3.5, the input means 3.6, the camera(s) 3.7, the microphone(s) 3.8 and one or more loudspeakers/earpieces 3.9 may also be called as a user interface (UI).

The host device 3 may still have a positioning circuitry 3.10 for obtaining information of a location of the host device 3. Such positioning circuitry 3.10 may comprise a global navigation satellite system (GNSS) receiver (e.g. a GPS receiver, GLONASS receiver, Galileo receiver, etc.). In some embodiments, the host device 3 may obtain location information by utilizing information provided by a mobile communication system.

The above mentioned operational elements may be coupled via an interface circuitry 3.11 (I/O, Input/Output) to the controller 2.1 or the coupling between the elements and the controller may be realized in another appropriate way.

In the following, some details of the access point 4 will be described with reference to FIG. 4. The access point 4 is, for example, a base station of a wireless communication network. The access point 4 comprises a processing unit 4.1, such as a microprocessor. The access point 4 also comprises memory 4.2 for storing program code and data. The access point 4 further comprises a mobile communication circuitry 4.3 for communicating with the host device 3 and a fixed communication circuitry 4.4 for communicating with other parts of the wireless communication network 5, for example with a mobile switching center (MSC) 6. FIG. 4 also depicts an interface circuitry 4.5 for connecting the communication circuitries 4.3, 4.4 with the processing unit 4.1, but this is only one example how the processing unit 4.1 may be coupled with the communication circuitries 4.3, 4.4 to enable the communication with other entities. Furthermore, there may also be other parts in the access point 4 and the wireless communication network 5, but it is not necessary to describe them in more detail in this context.

In the following, the operation of the system 1 of FIG. 1 will be described in more detail. In this embodiment, it is assumed that the wearable device 2 communicates with the host device 3, and the host device 3 communicates with the access point 4. It is also assumed that the host device 3 performs positioning operations of the host device 3 and, indirectly, the wearable device 2. Furthermore, it is assumed in the following that information of the environment of the detected location is obtained from a digital twin database 7, but such digital twin database 7 may be part of the AR cloud, as was explained earlier in this specification.

It is first assumed that the user is carrying the wearable device 2 indoors and that the host device 3 and the wearable device 2 are in proximity to each other, for example within few meters distance so that the first communication circuitry 2.10 of the wearable device 2 and the local communication circuitry 3.3 of the host device 3 can have a wireless, mutual communication connection. The wireless mutual communication connection utilizes, for example, so-called Bluetooth™ technology or Wi-Fi®-technology. The wearable device 2 may perform simultaneous localization and mapping of the environment, wherein the wearable device 2 can build a map or a reconstruction of the environment. The wearable device 2 may use one or more of the sensors for that purpose. For example, the wearable device 2 may use the one or more cameras 2.9 to capture images of the environment, preferably stereo images, the short range radar 2.4 or a laser sensor, which may utilize e.g. a so-called time-of-flight (ToF) principle (distance measurement), and the inertial measurement unit for distance and location measurement. The wearable device 2 can use the captured images and distance and location measurement results to determine physical characteristics of the room such as walls, objects within the room etc., wherein that information may be used to build a three-dimensional (3D) map or a reconstruction of the environment. Such created information may comprise point clouds of objects and walls of the room, for example. This kind of SLAM measurement can even produce mm-scale reconstruction of the indoor surfaces and objects.

This kind of operation where a wearable device such as a head mounted display reconstructs changes in the environment by utilizing sensor data may also be called as spatial computing.

The wearable device 2 sends the localization and mapping data or parts of them to the host device 3 at intervals. The data rate for that need not be very fast to save power consumption of the wearable device 2. As a non-limiting example the data rate may be much less than 1000 Hz. In other words, the localization and mapping data is sent to the host device 3 much less than 1000 times/second, possible even less than 100 times/second.

The host device 3 may obtain an estimation of the location of the host device 3 by using, for example, the positioning circuitry 3.10, and/or mobile network based positioning in which base stations (access points) of the mobile communication network are utilized. Once the location estimation has been determined, the host device 3 may obtain information of the environment of the detected location from the digital twin database 7. Together with context awareness, the wearable device 2 may display only the part of the digital twin data which is relevant. For example, when driving a car, helping digital road signs are of interest and these may be highlighted by the wearable device 2. As another example, when downhill skiing, the digital slalom poles are of interest, wherein the wearable device 2 may highlight those on the display unit(s) 2.3.

In order to be able to receive the digital twin data, the host device 3 may send the estimation of the location to the digital twin database 7 via, for example, the wireless communication network, or the host device 3 may comprise such database or parts of it.

The digital twin database 7 examines the estimation of the location and retrieves from the database digital twin data of the estimated location and sends the retrieved data to the host device 3. The retrieved data may not contain data on only the immediate proximity of the estimated location but also data further away from the estimated location. For example, a user may define a radius around the estimated location from which the digital twin data will be retrieved and transmitted to the host device 3, or the radius may be specified by an operator of the system 1, for example. It should be mentioned here that the radius does not necessarily mean a circle but is a some kind of hint how large area around the estimated location will be included in message(s) to be used in transmitting the digital twin data.

The digital twin database may comprise information on roads, traffic signs, buildings etc. of the physical environment. The digital twin database may also comprise data about location and interiors of buildings. For example, the data may comprise a map of interiors of a public building such as a library, a museum, a shop, etc. Hence, that kind of data may also be used to assist the simultaneous localization and mapping operations of the wearable device 2.

The host device 3 sends the digital twin data or a part of it to the wearable device 2, e.g. as a rough sample of the “digital twin” data, possibly containing some unnecessary data. Transmission of the digital twin data may be performed at relatively low speed (low bandwidth requirement) and latency is not critical. Also the rate at which the digital twin data is updated to the wearable device 2 (update frequency) may be relatively low. As an example, the transmission may be performed at the rate which substantially corresponds with the data rate from the wearable device 2 to the host device 3.

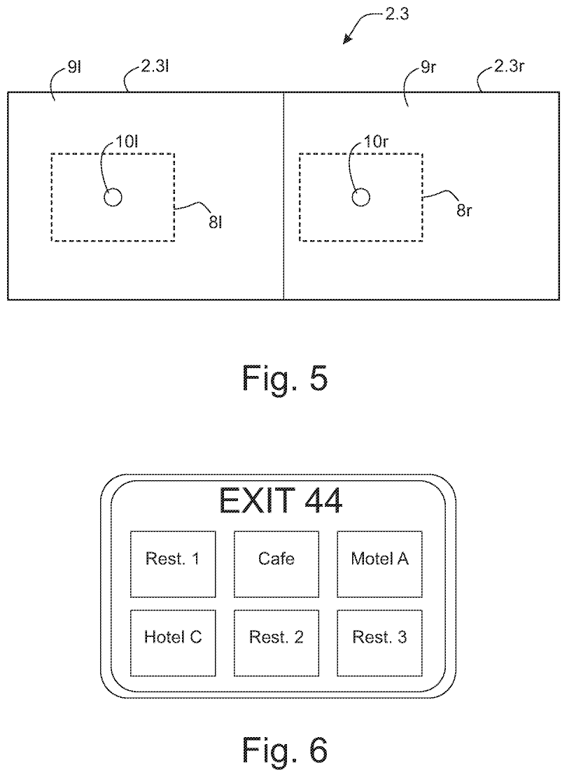

The wearable device 2 receives the digital twin data and may store it to the memory. The wearable device 2 examines the direction of the user's gaze and uses this information to determine which parts of the display area are in the direction of the user's gaze and which are farther away from the direction of the user's gaze. The area in the direction of the user's gaze can be called as a foveated area and the rest of the display area can be called as a peripheral area. This division of the display area can be used to determine which parts of the display need faster refreshing speed and more resolution and which parts can be refreshed less frequently and need less resolution. In other words, those part(s) of the display which have been classified as foveated area(s) are refreshed more frequently than those part(s) of the display which have been classified as peripheral area. Respectively, foveated area(s) should provide more accurate resolution than the peripheral area(s). An example of such division of the visual information displayed by the display unit(s) 2.3 of the wearable device 2 to a foveated area 8l, 8r and a peripheral area 9l, 9r is illustrated in FIG. 5. In this example the display 2.3 comprises a left display unit 2.3l and a right display unit 2.3r wherein also the foveated area comprises a foveated area 8l for the left eye and a foveated area 8r for the right eye and the peripheral area comprises a peripheral area 9l for the left eye and a peripheral area 9r for the right eye, respectively.

In the illustration of FIG. 5 the foveated areas 8l, 8r are depicted as rectangles but they can also have a form different from the rectangular form, such as an ellipse or a circle.

In accordance with an embodiment, visual information of the peripheral area 9 (peripheral data part) and visual information of the foveated area 8 (foveated data part) are transferred at different priority (resolution & latency) to the display unit 2.3. Hence, visual information of the foveated area 8 will be transferred with higher resolution and/or higher speed and shorter latency than visual information of the peripheral area 9. This effect does not remarkably affect to the visual experience by the user because human brains do not take so much into account visible information in the peripheral area than in the foveated area i.e. at the gaze point and nearby areas surrounding the gaze point. The gaze point of the left eye and the gaze point of the right eye are illustrated with small circles 10l, 10r in FIG. 5.

In accordance with an embodiment, visual information of the peripheral area 9 may also be updated by the wearable device 2 less frequently than the foveated area 8 and it may also be possible to freeze the peripheral area 9 (i.e. the visual information of the peripheral area 9 is not refreshed) for a while.

FIG. 8 also shows the principle of communication between entities of the system, in accordance with an embodiment. In this example, the host device 3 comprises a rough renderer and optionally an encoder for delivering the rough data to the wearable device 2. This communication connection may have low bandwidth requirement. Also the latency may not be critical and the update frequency may be relatively slow compared to the update frequency of at least the foveated area 8 of the display unit 2.3. The wearable device 2 has the SLAM renderer and optionally a decoder for decoding the optionally encoded data from the host device. The wearable device 2 may have high internal bandwidth, short latency and short update interval for the information shown by the display unit 2.3, at least in the foveated area(s) 8.

As was mentioned above, the digital twin data may comprise data of objects located in the physical environment of the wearable device 2. The wearable device 2 may use that data to simulate it on the display at a correct location. For example, the object may be a furniture wherein the processor 2.1 may produce information to be rendered by the display unit 2.3 showing the furniture e.g. with a different color or highlights the furniture in another way. The digital data may also refer to the manufacturer of the furniture wherein the display unit 2.3 may show some details of the manufacture, order information etc. at or beside the location where the furniture is displayed.

As another example, the user may be in a museum and watching a painting. The location information indicates the room and the gaze point indicates that the user is looking at that painting. The system then may use that information to retrieve from a database details of the painting and send that information to the wearable device 2 along with the digital twin data, for example. The wearable device 2 may then show that information by the display unit 2.3 beside the location where the painting is visible in the display unit 2.3.

In the above it was assumed that the wearable device 2 determines that it is indoors, wherein the simultaneous localization and mapping procedure may work with the help of the sensors of the wearable device 2. However, this is not always the case and at least outdoors it may not be possible to rely only on the sensors of the wearable device 2. In accordance with an embodiment, if the host device 3 deduces that location data received from the wearable device 2 is unreliable or contradictory to location data obtained by the host device 3, the host device 3 may use the location data of the host device 3 as an estimate of the location of the wearable device. It may also happen that the wearable device 2 deduces that it cannot determine its location reliably enough, wherein the wearable device 2 may send an indication of this to the host device 3.

The location determination outdoors may be performed, for example, by the positioning circuitry 3.10 of the host device 3. Also the wearable device 2 may comprise positioning circuitry which may be used in the determination of the location. If the positioning is based on satellite navigation system(s), location information generated by the positioning circuitry may not be in areas with high buildings or other obstacles which could suppress navigation satellite signals. The positioning may also utilize signals of the wireless communication network either alone or with the navigation satellite signals (e.g. assisted GPS, A-GPS). In the forthcoming fifth generation mobile communication network (5G) the constellation of the access points (base stations) is planned to be much denser than in the existing mobile communication networks (1G-4G LTE). In the future, 5G base station mesh may exist practically in every street corner within a geographical area. Each base station can be identified by its location, which may include, for example, information of the coordinates of the base station, type of the base station, is the base station indoors or not.

In other words, for example a 5G satellite constellation can be used as a substitute for or in addition to GNSS (GPS, GLONASS, . . . )

Therefore, the accuracy of the mobile communication network based positioning can be remarkably increased and it may also be possible to use mobile communication network positioning indoors and urban areas having high-rising buildings.

In accordance with an embodiment, pattern recognition is used to assist with the positioning by other technologies. As an example of a method how this could be implemented, is now explained shortly. The host device 3 sends the location estimation and a request for digital twin data to the access point 4, which forwards the location estimation and the request to the digital twin database 7. The digital twin database 7 examines the location and retrieves from the database digital twin data of the surroundings indicated by the location estimation. This digital twin data is then sent to the host device 3. The host device 3 sends the digital twin data to the wearable device 2 in which the wearable device 2 examines the visual information captured by the camera(s) 2.9 and uses pattern recognition to find out whether the image(s) contain known artifacts, such as signs, traffic signs, rocks, built infrastructure, etc. If an artifact is recognized in the image, the wearable device 2 examines the digital twin data to find out whether a corresponding artifact can be found from the digital twin data. If so, the wearable device 2 can then examine, for example, a distance and direction from the wearable device 2 to the recognized artifact and use that information to make the location estimation more accurate. The updated location estimate can then be used to determine whether the wearable device 2 is e.g. indoors or outdoors.

In addition to or instead of visual information also audible information may be used in the context determination. For example, traffic sounds may indicate that the user is outdoors and possibly near a road or street.

To put it briefly, context awareness can be based on detection of location and surrounding signals.

Furthermore, other devices such as smart watches, mobile phones, smart rings, cars, electric bicycles etc. may also be used in assisting the wearable device 2 to deduce the context. For example, sensors of the mobile phone may indicate some information related to the context and the sensor data or a further analyzed information (e.g. by the mobile phone on the basis of its sensor data) may be sent to the wearable device 2.

In accordance with an embodiment, the user may have started an exercise (e.g. running, cycling, skiing, . . . ) and have started a corresponding training application in a smart watch and indicated the nature of the training. Hence, this information may be transmitted to the wearable device 2 to be used in the context determination. In accordance with an embodiment, the wearable device 2 may utilize its own sensor data and optionally sensor data received from the other devices even without sending any data to the host device 3 or the access point 4 i.e. independent on the host device 3 or the access point 4.

The wearable device 2 may not always be stationary but may be moving. For example, the user who is carrying the wearable device 2 can be walking, running, cycling, skiing, travelling in a vehicle, such as a car, a bus, a tram, a train, an airplane, etc. That kind of context when the user is purely outdoors can be determined, for example, on the basis of succeeding location data and/or using one or more of the internal sensors of the wearable device 2, such as the gyroscope and/or the accelerometer. If the successive instants of location data indicate that the location is changing, the changes between different instants and the time lapsed between these instants can be used to determine the speed of the wearable device 2 (still, moving slowly, moving fast). Using a combination of the changes of location with sensor data the wearable device 2 may conclude whether the user is walking, running, cycling, skiing or travelling in a vehicle.

There may be different kinds of predetermined sensor output profiles for different kinds of movements wherein such profiles may be compared with actual sensor data and the closest match may indicate the type of movement.

If the wearable device 2 or the host device deduces that the user is indoors, the location data and the digital twin data can be used to determine in which kind of indoor context the user is at the moment. For example, the location data may indicate that the user is inside a museum, sport hall, cinema, theatre, music hall, mall, school or some other public location or at home or at a friend's home. In accordance with an embodiment, such information may then be used to, for example, switch the host device and possibly also the wearable device 2 to a silent mode, prevent image or video capturing, etc.

This kind of context determination may also be called as context awareness, because the wearable device 2 aims to become aware of the context where the wearable device 2 and the user are.

In judging the context machine learning may also be used to increase the reliability of the context determination. For example, when a context has been determined, information which led to the result, may be stored and combined with possible previously stored information from the similar context. Then, e.g. statistics of the combination may be used to provide more reliable context model.

The determined context may be utilized in many different ways. For example, if the context is music hall, the host device 3 may search from the internet information of the concert and provide concert related data to the wearable device 2 which may then show that information to the user. For example, if the wearable device 2 determines that the user is looking at a singer, the wearable device 2 may show the name of the singer and some background information related to the singer.

Some of the determined contexts, which may be called as a main context, may have sub contexts. For example, the skiing context may further be categorized to sub-contexts such as alpine skiing, off-hill skiing. Actually, outdoors context may be at a top of a hierarchy level wherein sub-context of the outdoors can include walking, running, skiing, etc. and these context may further have sub-contexts at a lower hierarchy level (e.g. the above mentioned alpine skiing, off-hill skiing).

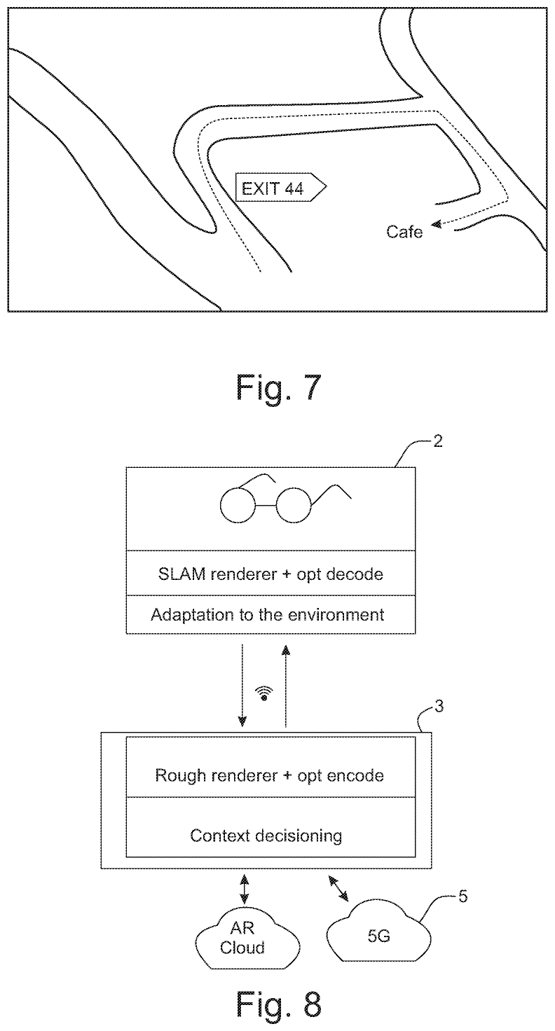

The eye camera(s) 2.10 of the wearable device 2 can be used for performing eye tracking operations and detecting eye blinks. Eye tracking can be used to determine the direction of the user's gaze. The wearable device 2 can utilize this information in controlling the augmented reality content on the display(s) 2.3. For example, the user gaze direction and physical objects location can be used to point objects. When the user looks at a certain physical feature, a sign for example, and double-blinks her eyes, the wearable device 2 could understand that the user is interested in that particular feature and accompanied digital twin data, based on the detected context. In accordance with an embodiment, double/triple blinks can be used to distinguish actions. For example, if the user is looking at a temperature control switch of the dashboard of a car, a double blink may cause that the temperature will be increased inside the car and a triple blink may cause that the temperature will be decreased inside the car. As another example, if the user is driving a car on a highway and a traffic sign of an exit intersection on the highway is visible. The wearable device 2 may obtain digital twin data related to the traffic sign and notice that there are several restaurants nearby the exit intersection. Logos of those restaurants may be produced on the location where the traffic sign is visible as augmented reality objects. An example of this is illustrated in FIG. 6. The user may then direct the gaze point to the logo of the restaurant where the user would like to visit. By e.g. double blinking his eyes the wearable device 2 deduces that the user would like to have driving instructions to that restaurant. The driving instructions may then be retrieved from the digital twin database 7 and transmitted to the wearable device 2, which shows the driving instructions to the user as augmented reality information. A simplified example is illustrated in FIG. 7. In accordance with another embodiment, the driving instructions are not shown by the wearable device 2 but they are delivered to a navigator of the car and shown by the navigator.

In accordance with an embodiment, the eye tracker procedure may also examine the size of the pupil(s) of the user's eye(s) and make some deductions from that. As an example, if the size of the pupil has increased when the user's gaze points to a certain object or to a certain direction, the wearable device 2 may assume that the user is particularly interested in that object or the view in that direction.

The above described foveated rendering can be utilized to reduce power consumption of the wearable device 2 e.g. so that only the essential data at the gaze point shall be rendered at full detail. Peripheral data can be rendered with significantly lower resolution, and it can be non-synchronized when compared to the foveated data (which in turn needs to be exact in terms of latency). Based on the gaze, the system shall detect whether user is looking at the augmented reality data or not; the wearable device 2 and other power consuming parts, like GPU's can even be partly switched off, if the user is not utilizing the augmented part, based on the user gaze point.

In the following, some further details of an example situation will be described. It is assumed that the user is sitting in a car and the wearable device 2 has correctly classified the context as a vehicle. Cars and other same kinds or vehicles typically have internal objects such as a dash board, a driving wheel and some control switches. Cars also have a windscreen and other transparent windows.

When the wearable device 2 is used inside a vehicle having windscreen and/or other windows (or transparent elements), the wearable device 2 may recognize which parts of the image captured by the camera 2.9 belong to the interior of the vehicle and which parts of the visual information belong to outside world (outdoors). This knowledge can then be used, for example, to distinguish traffic signs, roads and other outside world objects from objects belonging to the vehicle. Using the indoors/outdoors classification together with the eye tracking makes it possible to determine whether the user wishes to, for example, obtain augmented reality information related to indoors or outdoors.

In the vehicles the SLAM can be based on the same sensors as indoors case, but additionally the vehicle may have some special fiducial in order to place AR objects to exact places.

In accordance with an embodiment, it may also be possible to compare the size of the pupil to one or more thresholds. For example, if the size is smaller than a lower threshold, it may be an indication that the user is not concentrating to anything special act, wherein the user may be able to handle more information displayed by the display and/or produced by the loudspeaker 2.11. On the other hand, if the size is larger than a higher threshold, it may be an indication that the user is concentrating to some demanding act, wherein the user may not be able to handle much more information. Hence, additional augmented reality information may not be displayed by the display nor produced by the loudspeaker 2.11.

In the above described embodiments the wearable device 2 communicated with the host device 3 carried along the user. However, similar approaches are also possible in implementations where the wearable device 2 communicates directly or via a local wireless communication network (WLAN, Wi-Fi®) with the access point 4. Hence, the operations of the host device 3 are implemented either in the local wireless communication network or in the access point 4. In accordance with an embodiment, the wearable device 2 comprises circuitry for operating as a portable wireless communication device, such as a mobile phone. Such a circuitry may be able to communicate with the existing mobile phone networks (1G to 4G LTE) and the 5th generation mobile phone networks (5G).

In some situations the determined context may be utilized so that the circuitry related to the augmented reality may be totally or partly switched off to reduce power consumption of the wearable device. It may also be possible that only some AR operations will be allowed when a certain context has been determined.

The above described principles have some advantages. It is an aim to reduce power consumption of the wearable device 2 so that it may be used longer without recharging. It may even be possible to use the wearable device 2 a full working day without increasing battery capacity, for example, when the above described approaches are at least partly utilized. It may also be possible to implement with the overall architecture so that the number of sensors/signals utilized is optimized and possibly varied in different situations. Also the wireless protocol utilized in the communication between the wearable device 2 and the host device 3 may be designed so that unnecessary signaling is avoided and the transmission rate is kept as small as reasonable. To put it shortly, power consumption, along with thermal control, should be optimized. Data transmission and display play a remarkable role in the optimization process.

It should also be noted that the SLAM information, which is used, depends on the SLAM context. It should be noted that the embodiments of the present invention need not rely on certain AR display technology (waveguides, birdbaths, laser, OLED etc.) or to a certain SLAM technique (Stereo vision, ToF, short range radar, etc.) or on mobile phone tethered setup only (connectivity to 5G/6G edge computing is one of the choices).

This is more like protocol/method/architecture type of invention enabling the lightweight, cable-free design for full day use, enabling the full usage of SLAM and Cloud AR, and reducing the needed data bandwidth between the wearable device 2 and the host device 3.

The above described context awareness, enabled by the positional accuracy of the positioning circuitry (the wearable device 2 knows, when the user is indoors, outdoors, car . . . ), makes it possible for the SLAM method to adapt based on context.

In accordance with an embodiment, the wearable device 2 is just an IoT (Internet of Things) remote sensor, which communicates with the host device 3 (cloud or mobile phone).

In accordance with an embodiment, the wearable device 2 can operate together with other wearables (watches, earpods, rings) or other IoT devices (e.g. connected to a car, a bike, etc.), to receive crucial information that the host device 3 uses in processing e.g. the context awareness data.

In accordance with an embodiment, the wearable device 2 is mainly a remote display, but with onboard rendering capabilities, which are important for seamless augmented experience.

A seamless augmented reality experience would benefit if ambient illumination and scenery information as well as ambient sound is taken into account.

Many of the above described operations may be performed by the processing unit 2.1, 3.1, 4.1 of the wearable device 2, the host device 3 and/or the access point 4, respectively, together with the memory 2.2, 3.2, 4.2 and other circuitry of the devices.

In the following, some examples are provided related inter alia to reduction of power consumption of the wearable device 2.

According to one example, there is provided a method for producing and processing augmented reality information on a display of a device, wherein the method comprises:
obtaining information related to a location and pose of the device by using one or more sensors;
sending the location related information to a host device to retrieve environment data on the basis of the location related information;
receiving the environment data and data of at least one object from the host device;
producing an image of the object on the display at a location determined from the environment data and the information of the pose of the device.

According to one example, there is provided a method for retrieving environment data by a host device, wherein the method comprises:
receiving from a device information related to a location of the device;
retrieving from an environment database digital data related to the location;
determining a context of the device on the basis of the digital data and the location of the device;
obtaining data of at least one object related to the location;
sending the environment data, context data and data of the at least one object to the device.

According to one example, there is provided a method for optimizing power consumption of a device, wherein the method comprises:
obtaining information of a gaze point of a user on a display of the device;
using the gaze point to determine which area of the display belongs to a first part and which area belongs to a second part;
rendering visual data in the first part more frequently and with higher resolution than visual data in the second part.

1. A method for controlling power consumption of a wearable device, wherein the method comprises:
obtaining information from one or more sensors of the wearable device;
using the obtained sensor information to form a sensed context profile;
comparing the sensed context profile with a set of predetermined context profiles to determine a context of the wearable device; and
using the determined context to adjust at least one operation of the wearable device related to augmented reality.

2. The method according to claim 1 further comprising:
determining the context on the basis of the predetermined context profile which has the closest match with the sensed context profile.

3. The method according to claim 2 further comprising:
comparing similarities between the sensed context profile and the predetermined context profiles to obtain a confident measure for the predetermined context profiles;
comparing the confident measures with a threshold to find out which predetermined context provide context determination, which is enough confident; and
selecting those contexts indicated by those predetermined context profiles which were found out enough confident.

4. The method according to claim 1 further comprising:
preventing at least one operation of the wearable device related to augmented reality to reduce power consumption.

5. The method according to claim 1 further comprising:
obtaining information of a location of the wearable device;
communicating the location information to a communication network;
receiving from the communication network digital twin data related to the determined location; and
utilizing the digital twin data by the wearable device to produce augmented reality information.

6. The method according to claim 5 further comprising:
communicating with the communication network via a host device.

7. The method according to claim 6 further comprising:
informing the host device about motion of the wearable device with respect to the detected location for obtaining the digital twin data related to the determined location; and
receiving from the host device cropped digital twin data, which is based on the obtained digital twin data and cropped on the basis of the motion information.

8. The method according to claim 1 further comprising:
obtaining information about motion of the wearable device with respect to a detected location; and
using the motion information to predict which data part of a content is to be displayed by the wearable device.

9. The method according to claim 1 further comprising:
examining direction of a gaze of a user of the wearable device;
using the information of the gaze to determine which parts of a display area are in the direction of the user's gaze representing a foveated area and which are farther away from the direction of the user's gaze representing a peripheral area;
updating the visual information displayed at the foveated area more often than the peripheral area to reduce power consumption.

10. The method according to claim 1 further comprising:
examining direction of a gaze of a user of the wearable device;
using the information of the gaze to determine which parts of a display area are in the direction of the user's gaze representing a foveated area and which are farther away from the direction of the user's gaze representing a peripheral area;
performing at least one of the following to reduce power consumption:
updating visual information displayed at the foveated area more often than at the peripheral area;
displaying visual information at the foveated area with higher resolution than at the peripheral area;
transferring visual information to the foveated area with higher speed and shorter latency than to the peripheral area.

11. The method according to claim 1, wherein the sensor data comprises one or more of the following:
location data;
acceleration;
amount of illumination;
gyroscope data;
audible data;
images captured by a camera;
data from a radar.

12. The method according to claim 1 further comprising:
examining properties of a gaze of a user of the wearable device;
using the information of properties of the gaze to control the operation of the wearable device.

13. A wearable device comprising:
a first circuitry configured to obtain information from one or more sensors of the wearable device;
a second circuitry configured to use the obtained sensor information to form a sensed context profile;
a third circuitry configured to compare the sensed context profile with a set of predetermined context profiles to determine a context of the wearable device; and
a fourth circuitry configured to use the determined context to adjust at least one operation of the wearable device related to augmented reality.

14. The wearable device according to claim 13, wherein the third circuitry is further configured to:
determine the context on the basis of the predetermined context profile which has the closest match with the sensed context profile.

15. The wearable device according to claim 14, wherein the third circuitry is further configured to:
compare similarities between the sensed context profile and the predetermined context profiles to obtain a confident measure for the predetermined context profiles;
compare the confident measures with a threshold to find out which predetermined context provide context determination, which is enough confident; and
select those contexts indicated by those predetermined context profiles which were found out enough confident.

16. The wearable device according to claim 13, wherein the fourth circuitry is further configured to:
prevent at least one operation of the wearable device related to augmented reality to reduce power consumption.

17. The wearable device according to claim 13 further configured to:
obtain information of a location of the wearable device;
communicate the location information to a communication network;
receive from the communication network digital twin data related to the determined location; and
utilize the digital twin data by the wearable device to produce augmented reality information.

18. The wearable device according to claim 13, wherein the fourth circuitry is further configured to:
inform the host device about motion of the wearable device with respect to a detected location for obtaining the digital twin data related to the determined location; and
receive from the host device cropped digital twin data, which is based on the obtained digital twin data and cropped on the basis of the motion information.

19. The wearable device according to claim 13, wherein the fourth circuitry is further configured to:
obtain information about motion of the wearable device with respect to a detected location; and
use the motion information to predict which data part of a content is to be displayed by the wearable device.

20. A head mounted display comprising:
a first circuitry configured to obtain information from one or more sensors of the wearable device;
a first circuitry configured to use the obtained sensor information to form a sensed context profile;
a first circuitry configured to compare the sensed context profile with a set of predetermined context profiles to determine a context of the wearable device; and
a first circuitry configured to use the determined context to adjust at least one operation of the wearable device related to augmented reality.
